(19) United States
(12) Patent Application Publication
(10) Pub. No.: US 2014/0086814 A1
(43) Pub. Date: Mar. 27, 2014

(54) Production of Li2MSiO4 electrode materials in amine solvent

(71) Applicant: Peter Jerome Cowdery-Corvan, Webster, NY (US)

(72) Inventor: Peter Jerome Cowdery-Corvan, Webster, NY (US)

(21) Appl. No.: 13/998,043

(22) Filed: Sep. 25, 2013

Related U.S. Application Data
(60) Provisional application No. 61/744,396, filed on Sep. 25, 2012.
(60) Provisional application No. 61/958,943, filed on Aug. 9, 2013.

(51) Int. Cl. H01M 4/58; C01B 33/32

(52) U.S. Cl. CPC H01M 4/5825; C01B 33/32
USPC 423/333

(57) ABSTRACT

A process for the production of Li₂MSiO₄, wherein M is Mn, Fe, or Co, is disclosed. The process uses an atmospheric-pressure solvo-thermal synthesis in a high boiling-point amine solvent selected to be stable with respect to decomposition over the solvothermal process conditions. A subsequent calcination results in a substantially single phase powder of crystalline Li₂MSiO₄. The solvothermal solvent is recoverable and reusable. The process also uses on an excess of lithium in the starting materials mix to promote phase-purity of the Li₂MSiO₄ crystalline phase. The Li₂MSiO₄ material is used as a cathode material in a lithium ion battery cell.

### CROSS-REFERENCE TO RELATED APPLICATIONS

This patent application claims priority to Provisional Application Ser. No. 61/744,396, PRODUCTION OF Li₂MSiO₄ ELECTRODE MATERIALS IN AMINE SOLVENT, filed Sep. 25, 2012; and to Provisional Application Ser. No. 61/958,943, METHOD FOR MAKING Li₂MSiO₄ NANOSHEETS, filed Jul. 17, 2013; the disclosures of which are incorporated herein by reference in their entirety.

### FIELD OF THE INVENTION

The invention relates to methods of synthesis of lithium metal-silicate materials, to the use thereof as battery electrodes, and to battery cells that incorporate such electrodes.

### BACKGROUND OF THE INVENTION

Given the importance of battery technology in enabling the recent profusion of portable/mobile electronic and cordless electric devices, battery materials having improved performance and/or lower cost are of increasing interest. Electric and hybrid vehicles are another major application generating demand for high performance battery technology. Commercially, the most important developing battery class today, having the highest energy density and excellent cycling performance, is the lithium ion battery. Although performance improvement is an ongoing goal, perhaps the biggest challenge for lithium ion batteries is cost reduction.

Research and development is active around the world in all aspects of lithium ion battery composition, design, and manufacturing. Of particularly high importance are efforts aimed at the development of new lower cost, high performance anode and cathode electrode materials, and low cost material preparation methods. The safety of lithium batteries is also a general concern.

A class of cathode materials under current investigation is the lithium metal-silicates having the general formula Li₂MSiO₄, wherein M can be, for example, Fe, Mn, Co or Ni. These materials crystallize as a layered intercalation compound in which lithium ions can pass in and out of the structure. Of particular interest is the theoretical possibility that up to two lithium ions per formula unit may be extracted from, and returned to, the structure in a given charge/discharge cycle, thereby leading to very high charge storage capacities. Confirmation of this theoretical advantage has been recently realized experimentally, as has been reported by Rangappa et al., Nano Lett. 2012 Mar. 14; 12(3):1146-51. The ability to insert and extract two lithium ions per formula unit in a cyclic manner has been attributed to the extremely thin nanosheet morphology of the materials. However, the synthetic method employed both high temperature and high pressure (400° C./5878 psi) processing conditions, and is not well-suited to manufacturing.

Once more, cost is a major concern for commercial applications. From the viewpoint of raw material cost, and potentially high storage density, the Li₂MSiO₄ materials present an opportunity to improve the cost/performance position in lithium ion battery technology. Of course material processing cost must also be considered as materials synthesis/processing contribute significantly to the overall cost. In general, traditional solid state synthetic methods use substantial amounts of time and energy to achieve a level of comminution of the input materials needed to enable the solid state reaction of the input materials to progress at a sufficient rate during a calcining and/or a sintering step that ultimately gives rise to the desired reaction product phase. The high temperature reaction portion of the process, known as calcining, is energy intensive, requiring both high temperatures and long times at high temperature, because the process relies on diffusion in the solid state over relatively long distances, given the particle-sizes typically achieved, for example, by mechanical milling of input materials.

Materials in the Li₂MSiO₄ family have been produced by a number of routes including traditional solid state ceramic processes. Aravindan et al. in J. Mater. Chem., 2011, 21, 2470, entitled “Influence of carbon towards improved lithium storage properties of Li₂MnSiO₄ cathodes” disclose a process using a stoichiometric solid state synthesis from LiOH hydrate, MnCO₃, and SiO₂ starting materials. However, they report that the use of tetraethylene glycol (TEG) as a solvent in a solvothermal process results in the formation of tarry thermal decomposition by-products that are tedious to remove, and are difficult to control.

Aravindan et al. also report the use of adipic acid as a gelling and capping agent to assist in the synthesis and to prevent particle aggregation during sintering. These workers specifically disclose a sintering temperature of 900° C., where after the resulting Li₂MSiO₄ material is not phase-pure, and scanning electron microscopy (SEM) reveals particle sizes in the 1 to 10 micrometer range with substantial particle aggregation.

US 2011/0269022 A1 to Takahiro Kawakami and Masaki Yamakaji discloses the synthesis of Li₂MnSiO₄ and Li₂FeSiO₄ by a traditional solid state synthetic approach, the latter compound from lithium carbonate, iron oxalate and silicon dioxide starting materials. Also disclosed are positive electrode materials comprised of Li₂MSiO₄, wherein M can be Fe, Mn, or Co, alone or in combination. Sintering temperatures reported are from 700-1100° C.

In “Microwave-Solvothermal Synthesis of Nanostructured Li₂MSiO₄/C (M=Mn and Fe) Cathodes for Lithium-Ion Batteries” by T. Muraliganth et al., Chem. Mater. 2010, 22, 5754-5761, a high-pressure solvothermal preparation of the title compounds is disclosed. Use of a glycol ether, specifically tetraethylene glycol (TEG), is reported as the solvent for the process. Lithium hydroxide, manganese acetate, and tetraethyl orthosilicate (TEOS), in stoichiometric ratios of the cations, were combined in TEG in a closed reaction vessel. The mixture was heated under stirring by microwave excitation to a temperature of 300° C. and a pressure of 30 atmospheres. The requirement of high-pressure sealed-reactor processing is, however, a significant detriment to achieving low-cost, high-volume manufacturing of Li₂MSiO₄. The reaction product was washed repeatedly in acetone to remove unwanted reaction by-products, and the authors report high air sensitivity of the reaction product. The authors report single phase target product after a process step of heating the solvothermal reaction product at 650° C. (in Argon gas), the single phase target product being characterized by an average grain size of about 20 nm. The small grain size results from the solution-based preparation and is beneficial because of improved ionic and electronic conduction. However, due to the low intrinsic electronic conductivity of the Li₂MSiO₄ materials, it is common in the art to coat the Li₂MSiO₄ particles with carbon. None the less, these authors report poor charge/discharge rate performance and severe energy storage capacity fade during battery cycling of Li₂MnSiO₄/C composites.

Commonly assigned U.S. patent application Ser. No. 13/847,170, IMPROVED METHOD FOR PRODUCTION OF Li2MSiO4 ELECTRODE MATERIALS, filed Mar. 19, 2013 discloses that certain high boiling-point alcohols can be used in an atmospheric pressure solvothermal process to produce Li₂MSiO₄ nanomaterials without incurring thermal decomposition of the solvent. In this way, some limitations of the prior art had been overcome. However, the inventor has noted that use of a high-boiling alcohol solvent alone often results in gelation and clumping of solid reactant materials (e.g. LiOH) during the initial solvothermal heating step. This clumping effect hinders both the rate of reaction and the uniformity of the Li₂MSiO₄ precursor material produced by the initial solvothermal reaction step.

What is needed is a rapid, low cost, atmospheric atmosphere process for forming Li₂MSiO₄ nanomaterials that overcomes the difficulties encountered by earlier workers, that efficiently produces high-purity, air and moisture stable Li₂MSiO₄ materials with a small particle size, thereby enabling a lithium ion battery having high charge storage density, good charge/discharge rate performance, and extended cyclability.

### SUMMARY OF THE INVENTION

In one aspect, the invention is directed to a solvent-based atmospheric pressure process for the preparation of Li₂MSiO₄ nanomaterial, wherein the process makes use of a process-stable high-boiling amine solvent to precipitate Li₂MSiO₄ precursor materials that are subsequently calcined in an inert atmosphere. In a particular embodiment, the inventive process employs a solvent mixture of a high-boiling amine and a high-boiling alcohol. In particular embodiments, the metal M may be selected from the group consisting of Mn, Fe, Co and Ni.

In a second aspect, the invention relates to a low-cost process for the preparation of Li₂MSiO₄, wherein M is selected from Fe, Mn, Co, and Ni, and wherein an excess of Li or Si is employed to enhance formation of a crystalline Li₂MSiO₄ phase.

In a third aspect, the invention relates to a low-cost process for the preparation of Li₂MSiO₄, wherein M is selected from Fe, Mn, Co, and Ni, and wherein the Li₂MSiO₄ nanomaterial is characterized by a particle dimension less than about 25 nanometers.

In yet another aspect, the invention relates to lithium battery electrodes and lithium battery cells that comprise Li₂MSiO₄ materials, wherein M is selected from Fe, Mn, Co, and Ni, prepared by the processes of the invention.

### BRIEF DESCRIPTION OF THE DRAWINGS

FIG. 1 is an X-ray diffraction spectrum of the product of Example 3, along with the theoretical X-ray diffraction line spectra of Li₂MnSiO₄ (narrow continuous lines) and MnO (bold dashed lines).

FIG. 2 is an overlay of the X-ray diffraction spectra for the products of Example 2 (oleyl alcohol solvent) and Example 3 (oleyl amine solvent) in the region of the (010) diffraction peak of Li₂MnSiO₄.

FIG. 3 is an X-ray diffraction spectrum of the product of Example 5D, along with the theoretical X-ray diffraction line spectra of Li₂MnSiO₄ (narrow continuous lines).

### DETAILED DESCRIPTION OF THE INVENTION

In this application, the term nanoparticle includes particles having at least one dimension less than 100 nm. The particle thickness or the geometric particle diameter can be estimated, for example, by analysis of transmission electron micrographs (TEM). Alternatively, the average crystallite size of a sample of nanopartices can be estimated by analysis of X-ray diffraction peak width using the Scherrer method. Herein, the smallest dimension of a particle is considered to be the smallest parameter among the thickness, diameter or average crystallite size determined by any of these techniques.

In a particular embodiment, the invention is directed to low cost processes that yield materials in the Li₂MSiO₄ system having favorable properties for use as cathode materials in lithium batteries. For the purposes of the invention, the metal M in the above formula comprises the elements, Fe, Mn, Co, and Ni, alone or in any combination such that in total they comprise one mole of M per mole of Li₂MSiO₄.

Considerations for achieving a low cost process include elimination of time-consuming mechanical comminution processes, freedom from tedious and waste-product-producing wash steps, the use of relatively low processing temperatures and reduced times at processing temperatures, the use of atmospheric pressure throughout the processing steps, and the ability to recycle solvent materials used in the process.

Target properties for the Li₂MSiO₄ materials formed by the inventive processes and used as lithium battery cathodes include crystalline structures enabling cation intercalation, fine-grain non-aggregated microstructure, and high discharge capacity, rate performance, and cyclability. The production of high quality Li₂MSiO₄ materials requires excellent control of the material manufacturing process

In accordance with various embodiments of the invention, a solvothermal process begins with readily available starting materials that are soluble in, or will complex with, the solvent to be employed. For the lithium starting material, LiOH, as well as the monohydrate and dihydrates of LiOH, are potential choices. Lithium oxalate, lithium-methoxide, lithium-isoproproxide, and lithium-butoxide can also be used. In various embodiments the metal M in the chemical formula Li₂MSiO₄ may be selected from the group consisting of Mn, Fe, Co and Ni. Starting materials for manganese (Mn) include, but are not limited to, Mn(acetate)₂ tetrahydrate, Mn(2-ethylhexanoate)₂, Mn(acetylacetonate)₂ and Mn(naphthenate)₂. Silicon (Si) containing starting materials include, but are not limited to, tetraethyl ortho-silicate (Si(OEt)₄), tetra-methyl ortho-silicate, silicon tetra-acetate, fumed silica, and colloidal SiO₂.

In a particular embodiment, materials containing Li, M and Si are combined in stoichiometric proportion corresponding to the chemical formula Li₂MSiO₄. In other words, the molar ratios of (Li:M:Si) are (2:1:1).

In other embodiments, a molar excess or one or more of the Li, M and Si elements is employed. In various embodiments, the lithium excess ranges from 0% to about 10%, from 0% to about 20%, from 0% to about 30%, or from 0% to about 40% greater than the 2:1 molar ratio of lithium to metal or of lithium to silicon express in the chemical formula Li₂MSiO₄. Alternatively, the lithium excess ranges of these various embodiments may be expressed as follows: the molar ratio of lithium to metal (M) or of lithium to silicon ranges from 2.0 to about 2.2, from 2.0 to about 2.4, from 2.0 to about 2.6, or from 2.0 to about 2.8. In a specific embodiment, the excess amount of lithium is about 25 mole %.

In some embodiments, the excess lithium may promote the formation of a substantially single phase Li₂MSiO₄ material. In some other embodiments, wherein the amount of excess lithium employed is above the stated range, an intractable gel may form.

In other embodiments, a molar excess the metal M or silicon (Si) is employed. In particular embodiments the molar excess of silicon relative to the metal M ranges from 0% to about 10%. In particular embodiments, a molar excess of silicon relative to manganese ranges from 0% to about 10%. In a specific embodiment, a molar excess of silicon relative to manganese of about 5%, is employed.

In particular embodiments, the starting materials as described above are combined in a reflux apparatus with an aliquot of a high boiling-point solvent. The reflux apparatus may also include a distillate collection means. In some embodiments, the ratio of the mass of combined starting materials to the mass of high boiling-point solvents is in the range of about 0.05 to about 0.25. In particular embodiments, air in the reflux apparatus is replaced with an inert gas, such as nitrogen or argon, and the reaction mixture is heated to a temperature in the range of about 200° C. to about 300° C., or higher, optionally, with continuous or intermittent agitation or stirring. In general, after several hours, a reaction product forms as a solid precipitate in a still clear and colorless solvent supernatant.

The solid reaction product (precipitate) may be separated from the supernatant by solid-liquid separation processes known in the art, such as, for example, decantation or filtration. In general, as a result of conventional separation processes, a precipitate with substantial amounts of retained solvent is produced. In addition, the precipitate may be subsequently washed with a low-boiling solvent, such as, for example, toluene or isopropyl alcohol, to remove unreacted starting materials, reaction by-products or high-boiling solvents. Therefore, the retained solvent may comprise wash solvents in addition to the high boiling-point solvents used in the solvothermal process step.

In general, once more, when first separated and optionally washed, the solid reaction product (precipitate) formed during the solvothermal process step will retain a substantial amount of solvent, and may be variously described as a wet, damp or paste-like precursor material. In particular embodiments, X-ray diffraction (XRD) analysis of the wet precursor material may reveal the presence of a substantial amount of the crystalline Li₂MSiO₄ phase. However, further heating of the wet precursor material in an inert atmosphere results in the formation of substantially single-phase Li₂MSiO₄ as revealed by XRD. This heating process is herein referred to as calcining of the Li₂MSiO₄ precursor material. In particular embodiments calcining temperatures are in the range of about 600° C. to about 700° C. The separated and optionally washed solid reaction product is thus a precursor to the desired substantially single-phase Li₂MSiO₄ product.

The inventor has discovered that certain high boiling point amines can be used in an atmospheric pressure solvothermal process to produce Li₂MSiO₄ in the intercalation crystalline structure. In some embodiments, such amines have boiling points (at atmospheric pressure) of 200° C. or above and are liquid at room temperature. In general, the solvent should be stable against thermal decomposition reactions during the liquid phase portion of the synthetic process. Amines having high boiling points but which are solids at room temperature are also useful for the purposes of the invention. The organic amine solvent can be a saturated or unsaturated monoamine or a saturated or unsaturated polyamine. In certain embodiments, high boiling-point aromatic amines, including but not limited to, non-toxic amines or low cost aromatic amines, can be used. Combinations of such amines are also useful. In particular embodiments, one or more amines having boiling points below 200° C. are used in combination with one or more amines having boiling points of 200° C. and above. It is sometimes advantageous to include a reactive solvent which may be an alcohol or amine, that when heated in the presence of metal-containing starting materials, can result in the production of intermediate components. The favorable intermediate metal organic components may, for example, be not easily obtainable commercially or may be expensive when sourced. It may be necessary to allow any unreacted solvent having a boiling point below about 200° C. to escape in order that favorable solvothermal conditions can be reached.

Exemplary amines for the purposes of the invention include but are not limited to:
Diethylenetriamine,
Triethylenetriamine,
N-formylpiperidine
1-(2-Aminoethyl)piperazine,
Quinoline,
o-toluidine
p-toluidine*,
o-anisidine,
m-anisidine,
octylamine,
decylamine,
laurylamine* (alternative known as dodecylamine),
cetylamine*,
stearylamine*,
oleylamine,
* signifies that the amine is a solid at room temperature.

In a particular embodiment, oleyl amine, which is liquid at room temperature, low cost, and stable in the inventive solvothermal process, is useful for the purposes of the invention. The stability that the oleyl amine solvent exhibits in the process conditions gives excellent control and reproducibility to the process. Additionally, following completion of the atmospheric pressure solvothermal heating step, the oleyl amine solvent may be collected, such as by decantation or filtration, and reused, making the process lower in cost and more environmentally friendly.

Other embodiments, wherein the solvothermal solvent comprises a mixture of an alcohol and an amine, such as, for example, oleyl alcohol and oleyl amine, have been found by the inventor to offer low cost and higher conversion of reactants into the desired Li₂MnSiO₄ product phase, during solvothermal synthesis. In Particular embodiments include those wherein the molar ratio of oleyl amine to oleyl alcohol is in the range of about 0.05 to about 0.25.

Commonly assigned U.S. patent application Ser. No. 13/847,170, IMPROVED METHOD FOR PRODUCTION OF Li2MSiO4 ELECTRODE MATERIALS, filed Mar. 19, 2013, incorporated herein by reference, discloses that certain high boiling-point alcohols can be used in an atmospheric pressure solvothermal process to produce Li₂MSiO₄ nanomaterials without incurring thermal decomposition of the solvent. However, the inventor has noted that use of a high-boiling alcohol solvent alone often results in gelation and clumping of solid reactant materials (e.g. LiOH) during the initial solvothermal heating step. This clumping effect hinders both the rate of reaction and the uniformity of the Li₂MSiO₄ precursor material produced by the initial solvothermal reaction step. Quite surprisingly, the inventor has discovered that inclusion of a high-boiling amine as a cosolvent along with the high-boiling alcohol substantially reduces the gelation and clumping of solid reactant materials during the initial solvothermal step. In a particular embodiment, use of a high-boiling amine/alcohol solvent mixture in the solvothermal precipitation step accelerates the rate of the reaction by producing a greater fraction of crystalline Li₂MSiO₄ in the precursor material. The precursor material is subsequently calcined in an inert atmosphere to produce the final Li₂MSiO₄ product.

In some embodiments, stable cosolvents suitable for use along with a high-boiling amine solvent in the solvothermal step of the invention include alcohols have boiling points (at atmospheric pressure) of about 200° C. or above and are liquid at room temperature. Alcohols having high boiling-points but which are solids at room temperature can also be useful cosolvents for the purposes of the invention. In various embodiments, the high-boiling amine solvent is a major or a minor component of a solvent mixture.

The organic alcohol cosolvent can be fatty saturated monoalcohols or polyols. In other embodiments, the organic alcohol cosolvent can be a fatty olefinic alcohol. Certain high boiling-point aromatic alcohols, preferably non-toxic, low-cost aromatic alcohols, can be used as cosolvents. In some embodiments, a combination of such alcohols are used as cosolvents along with a high-boiling amine.

Exemplary alcohols for use as cosolvents along with a high-boiling amine include, but are not limited to:
Benzyl alcohol,
2-Phenylethanol,
1-phenyl-2-propanol,
m-methylphenol,
Glycerol,
1,5-pentanediol,
1,3-Propanediol,
1-nonanol,
1-decanol,
1-undecanol,
1-dodecanol*,
1-hexadecanol(Cetyl alcohol)*,
cis-9-hexadecen-1-ol(palmitoleyl alcohol),
16-methylheptadecan-1-ol(isostearyl alcohol),
1-octadecanol(Steryl alcohol)*,
cis-9-octadecen-1-ol(oleyl alcohol),
1,4-Butanediol,
1,3-Butanediol, and,
1,6-hexanediol*.
* signifies that the alcohol is a solid at room temperature.

In particular embodiments, solvent combinations comprise oleylamine and oleyl alcohol, oleylamine and 1-hexadecanol(cetyl alcohol), dodecylamine and oleyl alcohol, and dodecylamine and 1-hexadecanol(cetyl alcohol).

In particular embodiments, after completion of the atmospheric pressure solvothermal step, the solvents may be collected and reused, making the process more environmentally friendly.

Commonly assigned Provisional Application Ser. No. 61/958,943, METHOD FOR MAKING Li₂MSiO₄ NANOSHEETS, filed Jul. 17, 2013; discloses that inclusion of a step to remove retained solvent or other volatile liquid materials, either before or during calcining of the wet precursor material, enables the calcined substantially single-phase Li₂MSiO₄ product to be rapidly exfoliated into nanosheets in a high yield when subjected to ultrasonic excitation. In particular embodiments, the step to remove retained solvent or other volatile materials includes a vacuum heating step, wherein the temperature is increased into a range of about 100° C. to about 500° C., and the pressure is reduced to less than atmospheric pressure. In particular embodiments the temperature is increased into a range of about 130° C. to about 400° C. In various embodiments, a high vacuum is applied to remove retained solvent or other volatile material, such that, for example, the pressure is reduced to a range from about 0.1 mm Hg to about 10 mm Hg, more particularly to a pressure of less than about 1 mm Hg. In particular embodiments, an inert gas, such as, for example, molecular nitrogen or argon, is present in the reduced pressure atmosphere (vacuum).

In particular embodiments, the processes described in Provisional Application Ser. No. 61/958,943 are specifically contemplated for removal of a retained high-boiling amine solvent following the solvothermal precipitation step.

In one embodiment of the invention, a process for making crystalline Li₂MSiO₄ having a nanosheet particle morphology is provided, comprising the following steps: forming a mixture comprising Li, a metal M and Si, together with an amount of a high boiling-point amine, optionally in combination with a high boiling-point alcohol; heating the mixture at atmospheric pressure, thereby forming a solid reaction product and a supernatant; separating the solid reaction product from the supernatant, thereby forming a wet precursor material; removing retained solvent or other volatile material from the wet precursor material, thereby forming a dry precursor material; calcining the dry precursor material to produce crystalline Li₂MSiO₄; and subjecting the crystalline Li₂MSiO₄ to an exfoliation process, thereby forming nanosheets of crystalline Li₂MSiO₄.

In a particular embodiment, the separation of the solid reaction product from the supernatant resulting from the solvothermal processing step is afforded in whole or in part by a vacuum heating step that removes solvent or another volatile material. In another embodiment, the separation of the solid reaction product from the supernatant resulting from the solvothermal processing step is afforded in whole or in part by heating the solid reaction product and supernatant in the presence of a predetermined amount of oxygen.

In other embodiments, the solvent cyclohexyl pyrrolidone is used as an exfoliation medium, either alone or in combination with NMP.

In various embodiments, the exfoliation process of the substantially single-phase Li₂MSiO₄ product material to produce dispersed individual Li₂MSiO₄ nanosheets is achieved by application of a form of mechanical agitation, such as, but not limited to, sonication, ultrasonication, stirring, such as magnetic stirring or propeller stirring, shaking, milling, such as ball or attritor milling, and the like.

In regard to some particular end-use applications, desired properties for the Li₂MSiO₄ product materials formed and used as lithium battery cathodes include crystalline structures enabling cation intercalation, fine-grain non-aggregated nanosheet microstructure that enable batteries with high discharge capacity, good rate performance, and extended cyclability. The production of high quality Li₂MSiO₄ materials requires excellent control of the material manufacturing process.

As is well known in the art, electronic conductivity in native Li₂MSiO₄ is insufficient for use in lithium ion batteries, requiring the use of a conducting matrix, such as carbon, around the particles of Li₂MSiO₄. The use of carbon to enhance electronic conductivity is known to diminish charge rate performance for batteries incorporating such composite electrode material systems. It is also known that rate performance is enhanced in composite electrodes by a fine-grained microstructure having high surface area.

As was described above it may be advantageous to increase the bulk electronic conductivity of Li₂MSiO₄ materials and composites for its application as a Li ion battery electrode. In general, inclusion of a graphite-forming precursor in the Li₂MSiO₄ precursor materials during calcining under inert atmosphere conditions is employed to form graphitic carbon in association with the Li₂MSiO₄ particles, whereby the graphite-precursor is converted to graphite by pyrolysis during the calcining. In one embodiment, a graphite-forming precursor is added to a wet Li₂MSiO₄ precursor material, followed by a step to remove retained solvent or other volatile material to form a dry precursor material, with subsequent calcination to form Li₂MSiO₄/C composite product materials. In another embodiment, a graphite-forming precursor is added to a dry Li₂MSiO₄ precursor material, which is subsequently calcined to form Li₂MSiO₄/C composite product material.

In various embodiments, graphite-forming precursors include, for example, mono-saccharides, di-saccharides, such as sucrose, poly-saccharides, poly-alcohols, such as polyvinyl alcohol (PVA), cellulose acetate, polyacrylonitrile, and polymethylacrylonitrile.

In another embodiment, graphitic carbon is introduced after the formation of the Li₂MSiO₄ nanosheet particles, wherein the calcining of the dry Li₂MSiO₄ precursor is done in the absence of a graphite former.

To further illustrate the invention and its advantages, the following examples are given, it being understood that the specific examples are not limiting.

### EXAMPLE 1

### Comparative Example of Solvothermal Synthesis of Li₂MnSiO₄ Using TEG as Solvent (pc-121)

Into a 250 ml round-bottom flask was placed 100 ml of tetraethylene glycol solvent (Aldrich), 5.515 g Mn(acetate)₂.4(H₂O), 1.08 g LiOH and 4.69 g Si(OEt)₄ (via syringe). The apparatus was equipped with a 250 cc heating mantle, a distillation head with condenser plus a nitrogen gas atmosphere. Stirring was continuous using a magnetic bar. The solution was degassed with N₂ prior to heating. The solution became a yellow color after all addenda were added and a white precipitate formed as the temperature approached reflux conditions. As the reflux continued, distillation of ethanol and water were initially observed. A light yellow liquid distilled over from 170-236° C.

The temperature in the reaction vessel increased to 270-305° C. and the reflux continued for a total of 12 hours. The liquid distilling over became darker yellow as the temperature increased (at constant heat input). By the end of the reflux step, 75 ml of distillate (dark yellow) was collected after coming off of the reaction flask. On cooling the reaction flask to room temperature, a dark brown/black tarry lump remained in the flask. About 30 ml of degassed acetone was added to the tarry reaction product. The reaction product did not appreciably dissolve so the flask was put into a N₂ filled glove bag and the contents extracted with a spatula into centrifuge tubes. The tubes were spun at 9.5 K rpm for 5 minutes and then the acetone supernatant was decanted. Then a second wash of acetone was added to the product, and the sealed centrifuge tubes were sonicated for ˜10 min and then spun again for 5 min@9.5 K rpm. The supernatant was again decanted and the tubes sealed, then placed in a vacuum desiccator. The two centrifuge tubes were put into a glove bag (under N₂) and transferred to two 4 dram vials. Weight of product at this point was 18 g. These vials were placed in a vacuum oven at 80° C. at a pressure of ˜0.2 inches Hg overnight. Weight of product after vacuum oven treatment was 12 g. Then the vials were put back into a glove bag (under N₂) and 5.11 g of product with organic contamination was put into a quartz boat and heated to 350° C. for 2 hours in a tube furnace under N₂. The tube of the tube furnace became coated with drops of organic solvent residue. The product was then heated while still in the tube furnace to temperature (˜700° C.) for 2 hours, with ramp up to and down from the set temperature totaling 3 hours up and 1.5 hours down, to complete the elimination of organics. The tube furnace exhibited considerable brown/yellow liquid condensed to the cooler walls. Evidently, the step of heating at 350° C. under N₂ was insufficient to remove volatiles from the solvo-thermal reaction product. The product of the 700° C. treatment was analyzed by X-ray diffraction (XRD) and by inductively coupled plasma atomic emission spectrometry (ICP-AES). XRD showed that the high temperature process yielded mainly the orthorhombic Li₂MnSiO₄ with some MnO also observed. ICP-AES revealed the elemental composition shown in TABLE 1 below.

TABLE 1

| | Analysis for Comparative | Theoretical |
|---|---|---|
| | Prep of Li₂MnSiO₄ in | calculation for |
| Element | % (wt/wt) | Li₂MnSiO₄ in % (wt/wt) |
| Li | 2.8 | 8.6 |
| Mn | 10 | 34 |
| Si | 4.9 | 17 |

The elemental composition shown above is a poor match to the theoretical calculation for Li₂MnSiO₄.

### EXAMPLE 2

### Comparative Example of Solvothermal Synthesis of Li₂MnSiO₄ Using Oleyl Alcohol Solvent (pc-160B)

Into a 250 ml round-bottom flask was placed 100 ml of oleyl alcohol. The container was then degassed and charged with N₂. Next 1.348 g LiOH (a 25% stoichiometric excess), 4.69 g of Si(OEt)₄, and 5.515 g of Mn(acetate)₂.4(H₂O) were placed in the reaction flask. The above reaction mixture was stirred continuously using a magnetic bar. The temperature of the contents of the reaction flask was then raised gradually over 90 minutes reaching a final temperature of about 340° C. and held constant for a total of about 8 hours. After overnight cooling, the flask was warmed with stirring to 50-60° C. to disperse the precipitate. The suspension of the reaction product was transferred in a glove bag into two centrifuge tubes and then spun at 9.5 krpm for 10 min. The supernatant was decanted and then degassed-toluene added to the tubes to wash the solid and the material was centrifuged again as above. A second and third wash with acetone was performed and the supernatant was poured off. The damp solid was transferred to a vial, placed in a tube furnace and heated to 85° C. under vacuum (PUMP) for 30 minutes, and then transferred to a sealed vacuum desiccator overnight. The sample was then placed in a quartz boat and transferred under N₂ blanket to a tube furnace and heated according to the following schedule: the temperature was increased linearly from near room temperature over a 3 hour period to reach 650° C. and then held at 650° C. for 6 hours. Cool down was also linear and over a period of 2 hours.

An XRD spectrum of the product was obtained, from which Scherrer analysis of the (010) peak width indicated that the average crystallite size in the Li₂MSiO₄ product phase was about 29 nm.

### EXAMPLE 3

### Inventive Solvothermal Synthesis of Li₂MnSiO₄ Using Oleyl Amine (Inventive, PC-171)

Into a 250 ml round-bottom flask was placed 150 ml of oleyl amine. The solvent was then degassed with N₂. Next 1.348 g LiOH (a 25% stoichiometric excess), 4.69 g of Si(OEt)₄, and 5.515 g of Mn(acetate)₂.4(H₂O) were placed in the reaction flask. The above reaction mixture was stirred continuously using a magnetic bar. The temperature of the contents of the reaction flask was then raised gradually over 90 minutes reaching a final temperature of about 340° C. and held constant for a total of about 8 hours. After overnight cooling, the reaction product had precipitated from the light yellow solvent. The flask containing the reaction product was transferred in a glove bag and the oleyl amine supernatant was decanted from the precipitate. The damp product was re-suspended in 80 cc degassed toluene. The resulting suspension was transferred into two centrifuge tubes and then spun at 9.5 krpm for 10 min. The supernatant was decanted and then degassed-toluene again added to the tubes to wash the solid and the material was centrifuged again as above. The damp solid was transferred to a vial, placed in a tube furnace and heated to 250° C. under vacuum (PUMP) for 30 minutes, and then transferred to a sealed vacuum desiccator overnight. The sample was then placed in a quartz boat and transferred under N₂ blanket to a tube furnace and heated according to the following schedule: the temperature was increased linearly from near room temperature over a 3 hour period to reach 650° C. and then held at 650° C. for 6 hours. Cool down was also linear and over a period of 2 hours. A jet-black powder product was formed as a result of the calcination step.

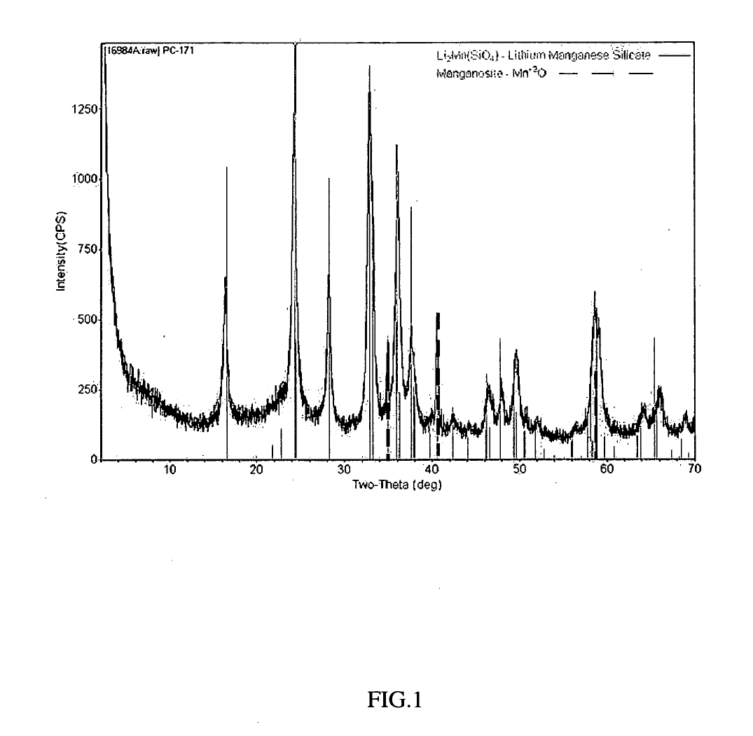

Analysis of the powder X-ray diffraction spectrum of the calcined jet-black powder product, shown in FIG. 1, revealed substantially pure Li₂MnSiO₄ in the orthorhombic phase. XRD Scherrer analysis of the (010) peak width indicated that the average crystallite size in the Li₂MSiO₄ product phase was about 17 nm.

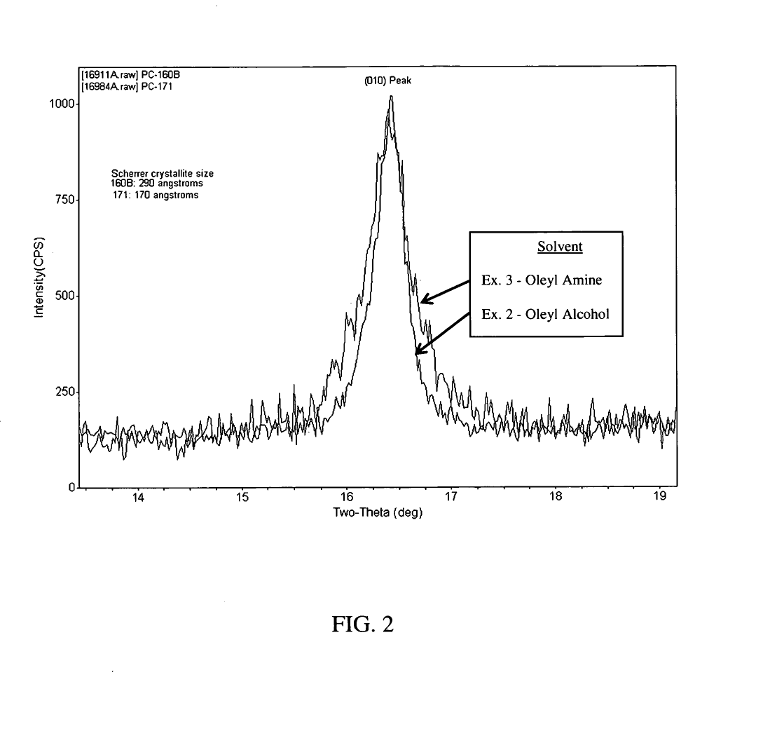

FIG. 2 shows the XRD peaks corresponding to the (010) lattice plane reflection for the products of Example 2 and Example 3. As can be clearly seen, the peak width of the product of Example 3, wherein oleyl amine solvent was used, is broader than that of Example 2, wherein oleyl alcohol was used. Thus, indicating a smaller average crystallite size when the oleyl amine solvent was used. More specifically, the average crystallite size for the comparative oleyl alcohol preparation was 29 nm versus the finding of 17 nm for the inventive oleyl amine preparation. The smaller crystallite size for the inventive amine solvent preparation is a highly desirable feature for Li ion battery cathodes.

The results of elemental composition analysis by inductively coupled plasma atomic emission spectrometry (ICP-AES) for the product prepared in Example 3 are shown in Table 2 below.

TABLE 2

| | Analysis for Inventive Prep of | Theoretical calculation for |
|---|---|---|
| Element | Li₂MnSiO₄ in % (wt/wt) | Li₂MnSiO₄ in % (wt/wt) |
| Li | 7.29 | 8.6 |
| Mn | 32.5 | 34 |
| Si | 13.9 | 17 |

The results of elemental analysis shown above demonstrate a composition much closer to the theoretical weight compositions of Li₂MnSiO₄than those values obtained by using the TEG solvent in comparative Example 1, shown in Table 1 above.

### EXAMPLE 4

### Inventive Solvothermal Synthesis of Li₂MnSiO₄ Using a Mixture of Oleyl Alcohol and Oleyl Amine Solvents (Inventive, PC-195)

A mixture of 130 ml of oleyl alcohol and 9.02 g of oleyl amine was degassed with N₂ in a 250 ml round bottom flask. Then 2.02 g LiOH (a 25% stoichiometric excess), 7.74 g Si(OEt)₄, and 8.27 g Mn(acetate)₂.4(H₂O) were added. The mixture was stirred continuously using a magnetic bar and the temperature was gradually increased to 328° C. and held at that temperature. Time above 300° C. was 3.25 hours. The reaction mixture was allowed to cool to room temperature and then reheated gradually, this time being held at 337° C. for about 5 hours. Total combined time the reaction mixture experienced temperatures above 300° C. was 8.25 hours. The suspension of the solid white reaction product was transferred into 4 centrifuge tubes in an inert atmosphere glove bag, then spun at 9.5 krpm for 20 min. The supernatant was decanted and then degassed toluene was added to the tubes to wash the particulate solid reaction product. The tubes were sonicated and centrifuged again as described above. The supernatant was poured off and a second toluene wash/centrifugation was performed, and again the supernatant poured off.

An XRD spectrum of the product was obtained, which revealed that an improved yield of the desired Li₂MnSiO₄ phase relative to the MnO impurity phase was produced as a result of inclusion of oleyl amine as a cosolvent.

### EXAMPLE 5

### Inventive Solvothermal Synthesis of Li₂MnSiO₄ Using a Mixture of Oleyl Alcohol and Dodecylamine Solvents (Inventive, PC-268)

A mixture of 130 ml of oleyl alcohol and 9.02 g of dodecylamine (laurylamine) was degassed with N₂ in a 500 ml round bottom flask. Then 2.02 g LiOH (a 25% stoichiometric excess), 7.74 g Si(OEt)₄ (a 10% stoichiometric excess), and 8.27 g Mn(acetate)₂.4(H₂O) were added. The mixture was stirred continuously using a magnetic bar and the temperature was gradually increased over 5 hours to 318° C. A bright white suspension resulted. The reaction mixture was allowed to cool to room temperature and then reheated gradually, this time being held at 337° C. for 4 hours.

The suspension of the solid reaction product was transferred into 4 centrifuge tubes in an inert atmosphere glove bag, then spun at 9.5 krpm for 20 min. The supernatant was decanted and then degassed toluene was added to the tubes to wash the particulate solid reaction product. The tubes were sonicated and centrifuged again as described above. The supernatant was poured off and a second toluene wash/centrifugation was performed, and again the supernatant poured off. This wet reaction product was labeled Example 5A.

The washed wet reaction product was coated with graphitic carbon by forming a mixture with sucrose and then calcining the mixture at 650° C. Specifically, wet reaction product (Example 5A) was combined with 20 wt %, 30 wt % and 40 wt % of sucrose (Examples 5B, 5C, 5D, respectively) and ground in a mortar/pestle to form a paste. The paste was put into an alumina boat and placed into a tube furnace and heated to 650° C. for 6 hours under flowing N₂.

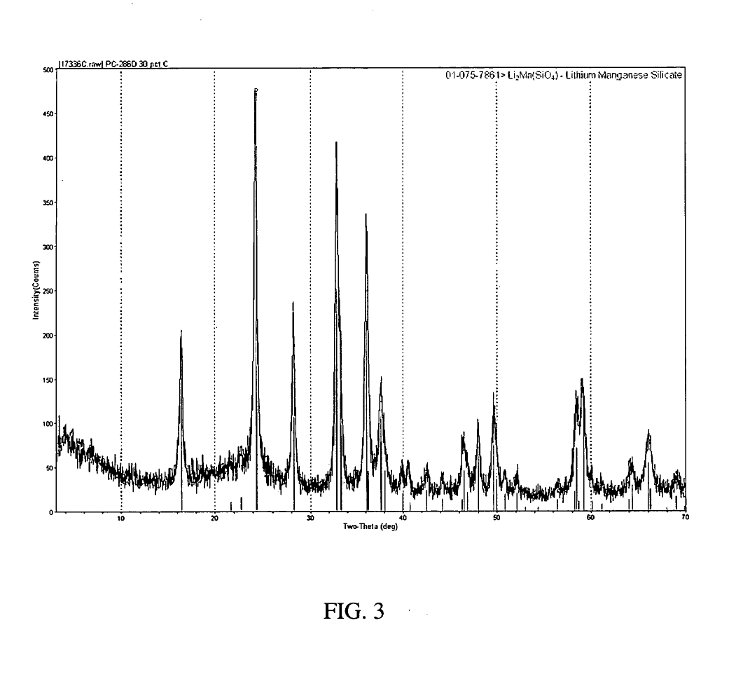

Analysis of the XRD spectrum of Example 5D shown in FIG. 3 revealed that substantially phase pure Li₂MnSiO₄ was produced. Scherrer analysis of the (010) peak width indicated an average crystallite size of 23 nm. Therefore, a reduction in average crystallite size from 29 nm to 23 nm resulted when a minor amount of the inventive dodecylamine was introduced into the oleyl alcohol as a cosolvent. The smaller crystallite size for the inventive high boiling amine solvent preparation is a highly desirable feature for Li ion battery cathodes.

### EXAMPLE 6

### Formation of Battery Cathode and Coin Cell Using Inventive Li₂MSiO₄ Material

A mixture containing a) graphitic carbon coated Li₂MnSiO₄ product prepared in Example 5C above (80% by weight), b) C-NERGYTM SUPER C65 conductive carbon (obtained from TIMCAL, Bodio, Switzerland) (10% by weight), and c) polyvinylidene fluoride binder polymer (10% by weight), was formed and dispersed in N-methylpyrrolidinone solvent. The resulting dispersion was coated onto aluminum foil and fabricated into a current collector as part of a battery cathode.

The Li₂MnSiO₄ coated cathode was then fabricated into a coin cell battery vs. a Li/Li(+) anode. The electrolyte used was 1.2M LiPF₆ in a 50/50 by volume blend of ethylenecarbonate and ethylmethylcarbonate.

The coin cell was tested using an Arbin BT-2000 battery cycler and cycled between 2V and 4.5V at a constant current rate of 10 mA/g. Electrochemical charge/discharge properties of the coin cell battery were observed.

The invention has been described in detail, with particular reference to certain embodiments thereof, but it will be understood that variations and modifications can be effected within the scope of the invention as described above, by a person of ordinary skill in the art, without departing from the scope of the invention.

What is claimed:

1. A method of making Li₂MSiO₄, comprising:
(a) forming a reaction mixture comprising a source of lithium, a source of a metal, a source of silicon, and a high-boiling amine;
(b) heating the reaction mixture, thereby forming a solid reaction product and a supernatant;
(c) separating the solid reaction product from the supernatant; and
(d) calcining the separated solid reaction product to produce Li₂MSiO₄.

2. The method of claim 1, wherein the molar ratio of Li to M or the molar ratio of Li to Si ranges from about 2.0 to about 2.

3. The method of claim 1, wherein the molar ratio of Si to M ranges from about 1.0 to about 1.2.

4. The method of claim 1, wherein M and Si are present in about equimolar proportion.

5. The method of claim 1, wherein the Li₂MSiO₄ is crystalline.

6. The method of claim 1, wherein the mixture in step (b) is at ambient pressure.

7. The method of claim 1, wherein the mixture in step (b) at under agitation.

8. The method of claim 1, wherein M is selected from the group consisting of Fe, Mn, Co and Ni.

9. The method of claim 1, wherein the high boiling amine comprises one or more amines at least one of which is characterized by a boiling point greater than or equal to 200° C.

10. The method of claim 1, wherein the high boiling amine, alone or in combination, is selected from the group consisting of oleylamine, stearylamine, cetylamine, dodecylamine and decylamine.

11. The method of claim 1, wherein the Li₂MSiO₄ produced is comprised of nanoparticles having a dimension of about 25 nm or less.

12. The method of claim 1, wherein the calcining step is performed at a temperature greater than or equal to about 600° C.

13. The method of claim 1, wherein the supernatant is collected and reused.

14. A battery electrode, comprising material prepared by the method of claim 1.

15. The battery electrode of claim 14, wherein the electrode functions as a cathode.

16. A battery cell prepared with an electrode comprised of material prepared by the method of claim 1.

17. The battery cell of claim 16, wherein the electrode is a cathode.
